(19) United States
(12) Patent Application Publication
(10) Pub. No.: US 2012/0278878 A1
(43) Pub. Date: Nov. 1, 2012

(54) SYSTEMS AND METHODS FOR ESTABLISHING SECURE VIRTUAL PRIVATE NETWORK COMMUNICATIONS USING NON-PRIVILEGED VPN CLIENT

(75) Inventors: Eric J. Barkie, Morrisville, NC (US); Benjamin L. Fletcher, Elmsford, NY (US); Andrew P. Wyskida, Fishkill, NY (US)

(73) Assignee: International Business Machines Corporation, Armonk, NY (US)

(21) Appl. No.: 13/095,437

(22) Filed: Apr. 27, 2011

(51) Int. Cl. G06F 21/00

(52) U.S. Cl. 726/15

(57) ABSTRACT

Systems and methods are provided for establishing secure VPN communications using processes executing in unprivileged user space. For example, systems and methods for establishing secure VPN communications implement user mode VPN clients and user mode network protocol stacks (e.g., TCP/IP stacks) that operate in user space without root access to an operating system of a computing device.

### TECHNICAL FIELD OF THE INVENTION

This disclosure relates generally to systems and methods for establishing secure VPN (Virtual Private Network) communications using processes executing in unprivileged user space and, in particular, to systems and methods for establishing secure VPN communications using user mode VPN clients and user mode network protocol stacks that operate in user space without root access to a computing device operating system.

### BACKGROUND

Virtual Private Networks (VPNs) enable secure, encrypted communications between private networks and remote users through public telecommunications networks such as the Internet. Remote users typically establish VPN connections by using VPN client software that is closely tied to the operating system (OS) of their devices. Many companies that develop operating systems for devices do not publicly provide third-party developers access to low level native features of the OS, which is necessary for these developers to develop and implement VPN solutions that are compatible and properly function with the device OS. Consequently, VPN client software is usually provided by the OS developer and is not easily added by third parties.

Client software (both standard and third party solutions) usually requires special device privileges to create a VPN connection. For secure communications, VPN connections typically require root access to the device OS and direct access to the native TCP/IP stack and network communications stacks on the computing device. These severe restrictions are thought to be necessary to protect remote devices from malicious programs (viruses etc. . . . ) and to enable secure communications over a notoriously unsecure public network such as the Internet.

The dramatic rise in popularity of “smart” mobile devices (phones with access to the Internet) has resulted in a demand for VPN communications between these devices and secure private networks. Many of the most popular commercially available devices do not include a VPN client. The VPN clients that do exist typically suffer from reliability issues, significantly drain battery life, are limited to specific infrastructures, and/or offer a clunky user experience. Existing alternatives can help but often introduce security issues (e.g. reverse proxies) or are severely limited in utility.

Traditionally, desktop OS users have had fully privileged (root) authority and have had the choice to obtain a VPN client from either the OS developer or third party developers. Recently, security has tightened in the desktop space and has been especially restrictive from the start in the mobile device space. In this regard, the ability to gain root access and utilize third party developed clients has diminished.

### SUMMARY OF THE INVENTION

Exemplary embodiments of the invention generally include systems and methods for establishing secure VPN communications using processes executing in unprivileged user space.

In particular, exemplary embodiments of the invention include systems and methods for establishing secure VPN communications using computing devices that implement user mode VPN clients and user mode network protocol stacks (e.g., TCP/IP stacks) that operate in user space without root access to an operating system of the computing device.

In one exemplary embodiment, a method for establishing a secure VPN (virtual private network) connection includes launching a VPN client running in non-privileged user space of a computing device, launching a network protocol stack running in non-privileged user space of the computing device, and establishing a secure VPN communication between an application running in non-privileged user space of the computing device and a remote server using the VPN client and network protocol stack running in non-privileged user space.

In other exemplary embodiments of the invention, launching a VPN client and network protocol stack includes making functions calls to a VPN library accessible in non-privileged user space of the computing device. The VPN library may be embedded code of the application.

In another exemplary embodiment of the invention, launching a network protocol stack includes initializing a user mode TCP/IP protocol stack in non-privileged user space. Traffic associated with the secure VPN communication may be forwarded through ports on a local loopback interface of an operating system of the computing device to VPN library functions. A port forwarder process running in non-privileged user space of the computing device is launched to control forwarding and rerouting of secure VPN traffic through a loopback process. The loopback process may include TCP port forwarding secure VPN traffic through a loopback interface of a native TCP/IP stack.

These and other exemplary embodiments, features, objects and advantages of the present invention will become apparent from the following detailed description of illustrative embodiments thereof, which is to be read in connection with the accompanying drawings.

### BRIEF DESCRIPTION OF THE DRAWINGS

FIG. 1A is a block diagram illustrating a traditional application platform that executes on a computing device for implementing secure VPN communications using processes that operate in privileged user space and privileged kernel space with root access to an operating system of the computing device.

FIG. 1B is a block diagram illustrating an application platform that executes on a computing device for implementing secure VPN communications using processes that operate in non-privileged user space without the need for root access to an operating system of the computing device.

FIG. 2 is a block diagram of a system for enabling secure VPN communications with a computing device having processes that operate in non-privileged user space to establish secure VPN communications without the need for root access to an operating system of the computing device, according to an exemplary embodiment of the invention.

FIG. 3 is a block diagram of system processes that operate in non-privileged user space of a computing device for enabling secure VPN communications without the need for root access to an operating system of the computing device, according to an exemplary embodiment of the invention.

FIG. 4 is a high-level flow diagram of a method for enabling secure VPN communications using processes that operate in non-privileged user space on a computing device without the need for root access to an operating system of the computing device, according to an exemplary embodiment of the invention.

FIGS. 5, 6, and 7 depict a flow diagram of a method for enabling secure VPN communications using processes that operate in non-privileged user space on a computing device without the need for root access to an operating system of the computing device, according to another exemplary embodiment of the invention.

FIG. 8 is a flow diagram illustrating a method for managing traffic between a target Intranet server and a client application using a port forwarding user mode process, according to an exemplary embodiment of the invention.

FIG. 9 illustrates a computer system in accordance with which one or more components/steps of the techniques of the invention may be implemented, according to an embodiment of the invention.

### DETAILED DESCRIPTION OF EXEMPLARY EMBODIMENTS

Exemplary embodiments as described herein include systems and methods for establishing secure VPN communications using processes executing in unprivileged user space. More specifically, exemplary systems and methods according to aspects of the invention implement user mode VPN clients and user mode network protocol stacks (e.g., TCP/IP stacks) that operate in user space to establish secure VPN connections without the need for root access to an operating system of the computing device. By way of example, systems and methods for establishing secure VPN communications combine a user mode VPN client and a user mode TCP/IP stack into an integrated user-mode process that can operate in non-privileged user space, without root access to an operating system of the client. In one embodiment, the VPN connection utilizes Cisco infrastructure using 256-bit AES SSL. Because the VPN client and TCP/IP stack are integrated user-mode processes, the VPN communications require no privileged access and can be implemented on severely restricted mobile platforms, for example.

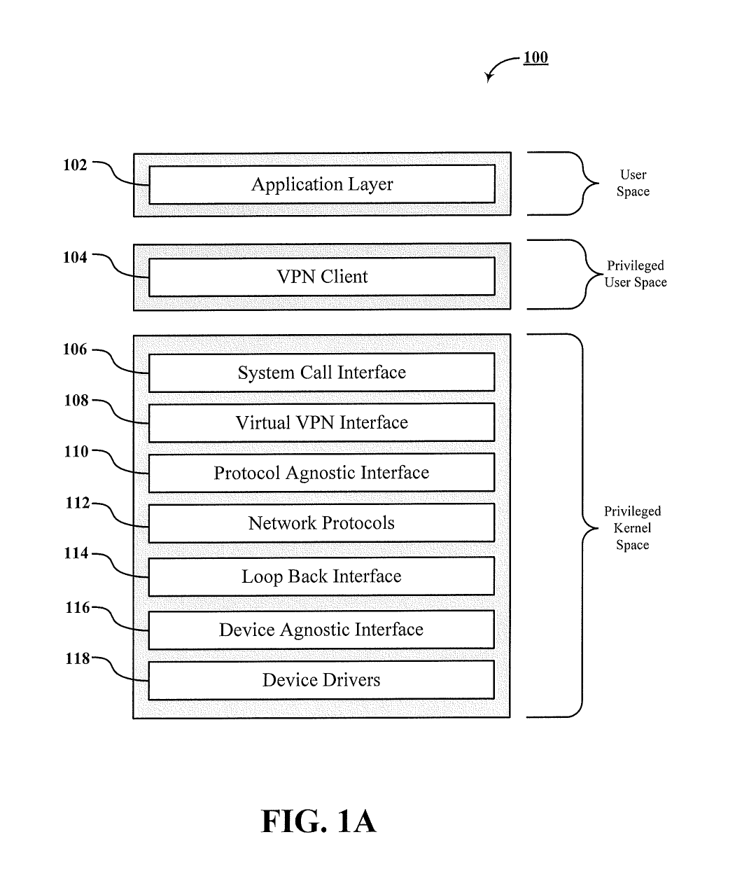

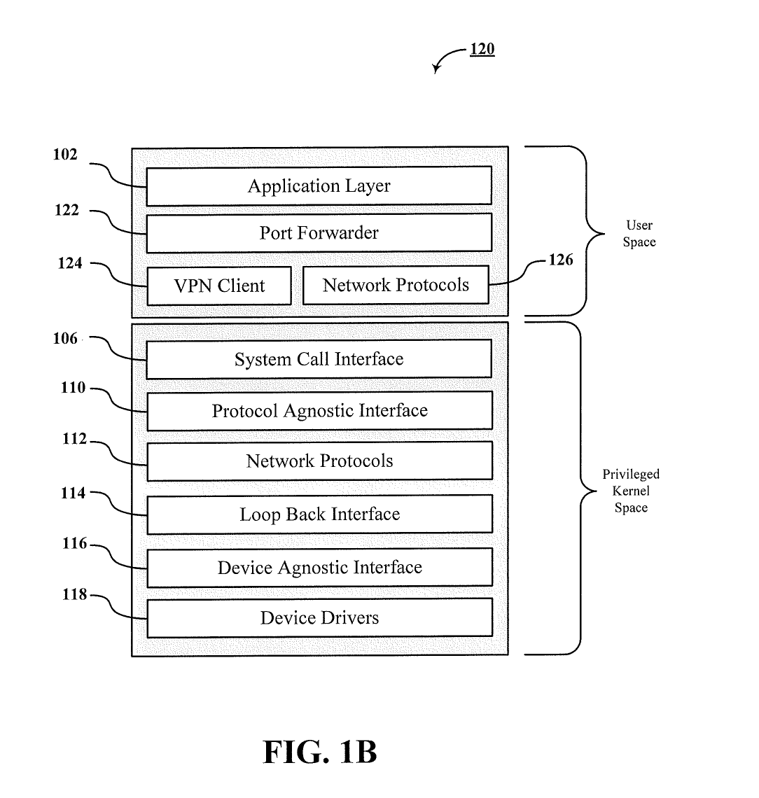

FIG. 1A is a block diagram illustrating a traditional application platform for implementing VPN communications on a computing device. More specifically, FIG. 1A is a block diagram illustrating a traditional application platform that executes on a computing device for implementing secure VPN communications using processes that operate in privileged user space and privileged kernel space with root access to an operating system of the computing device. As depicted in FIG. 1A, a conventional application platform 100 for implementing secure VPN communications comprises an application layer 102 that executes in non-privileged user space and a VPN client 104 that operates in privileged user space. The framework 100 further comprises a plurality of layers that execute in privileged kernel space such as a system call interface 106, a virtual VPN interface 108, a protocol agnostic interface 110, network protocols interface 112, a loop back interface 114, a device agnostic interface 116 and device drivers interface 118.

The application layer 102 represents any client application that operates in unprivileged user space, which makes use of the VPN client 104 for secure VPN communications. The VPN client 104 operates in privileged user space and communicates with application layers in privileged kernel space to provide secure VPN communications services to the application layer 102. The system call interface 106 is utilized by a process running in the non-privileged user space or the privileged user space to communicate with the privileged kernel space. The virtual VPN interface 108 is a virtual network device interface that is created with an internal device address when a VPN connection is established. The protocol agnostic interface 110 abstracts specifics of a virtual interface, and in particular, abstracts specifics of the network protocols layer 112. The network protocols layer 112 implements one or more native network communications stacks such as a native TCP/IP stack. The loopback interface 114 is a virtual network interface implemented in software which is integrated into the internal network infrastructure of the device. The device agnostic interface 116 implements the API to communicate with and write device drivers. The device drivers interface 118 implements APIs to communicate with kernel functions.

With the traditional model of FIG. 1A, either direct access or privileged access to the native OS is needed to establish secure VPN communications via the VPN client 104 and the virtual VPN interface 108. In contrast to the traditional model 100 of FIG. 1A, FIG. 1B is a block diagram illustrating an application platform that executes on a computing device for implementing secure VPN communications using processes that operate in non-privileged user space without the need for root access to an operating system of the computing device. The application platform 120 of FIG. 1B, is similar to the platform 100 of FIG. 1A, except that the platform 120 of FIG. 1B comprises a plurality of user mode processes, including a port forwarder 122, VPN client 124 and network communication protocol stack 126, which operate in user space to establish secure VPN communications over a computer network.

With the exemplary application platform model 120 of FIG. 1B, neither direct access nor privileged access to the OS is needed to establish secure VPN connections. In accordance with aspects of the present invention, a virtual VPN interface is not established in privileged kernel space (as with the traditional model 100 of FIG. 1A), but rather, a loop back interface 114 of a native network protocol stack 112 (e.g., a native TCP/IP stack) is accessed and certain ports are assigned on the loopback interface 114 to reroute and intercept VPN traffic through the present invention which implements software functions for forwarding VPN traffic through the loopback interface 122 and for creating a VPN client 124 and a TCP/IP network protocol stack 126 which operate in user space. With the exemplary model 120 of FIG. 1B, the VPN client 124, network protocol stack 126 (e.g., TCP/IP stack), and port forwarding functionality 122 are integrated user-mode processes in non-privileged user space. VPN network communications from the intranet to the application are controlled by the port forwarder 122 which reroutes secure VPN network traffic from the native TCP/IP stack 122, through the local loopback interface 114 to the TCP/IP stack in user space 126 where the application layer 102 can access the data. VPN communications from the application 102 to the intranet are written to the TCP/IP stack in user space 126 where the VPN traffic is rerouted by the port forwarder 122 through the loopback interface 114 to the native TCP/IP stack 122. In this regard, the application accesses a non-privileged stack in user space where the application does not need root access to the OS.

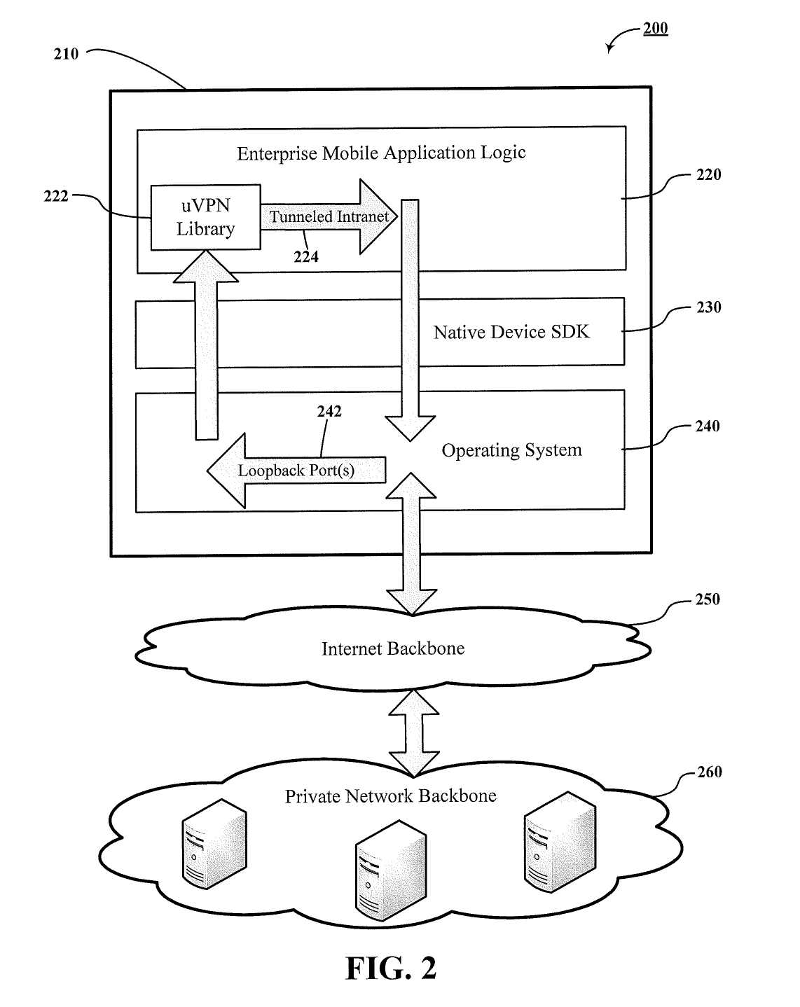

FIG. 2 is a block diagram of a system for enabling secure VPN communications, according to an exemplary embodiment of the invention. The system 200 comprises a computing device 210 that generally includes a client application 220, native device SDK (software developer kit), and a device operating system 240. The native device SDK 230 comprises a plurality of APIs that a Developer can utilize to access various features of the computing device 210. The computing device 210 can be mobile phone, mobile computing device, laptop computer, desktop computer, etc., which can implement the application platform model as depicted in FIG. 1B. The computing device 210 can access a communications network 250 (e.g., the internet), and access a private network 260 via secured VPN network connections over the communications network 250.

The application logic 220 comprises a VPN library 222 which comprises a plurality of functions that are used to initiate, open, control and close VPN connections in non-privileged user space. The VPN library 222 is a portable function library that can be embedded into any application logic, rather than being stand-alone software. The portable function library 222 is compatible with many different platforms, including, but not limited to Mac OSX, iOS, UNIX/Linux and Android platforms. In one exemplary embodiment of the invention, the VPN library 222 combines a user-mode VPN client and a user-mode TCP/IP network stack as an integrated user-mode process in user space. The library modules run in user space because the VPN client and the TCP/IP stack are not in the low level OS space, but rather they are implemented in the function library. The VPN library 222 also includes various functions to establish, disconnect, and query the VPN connectivity state.

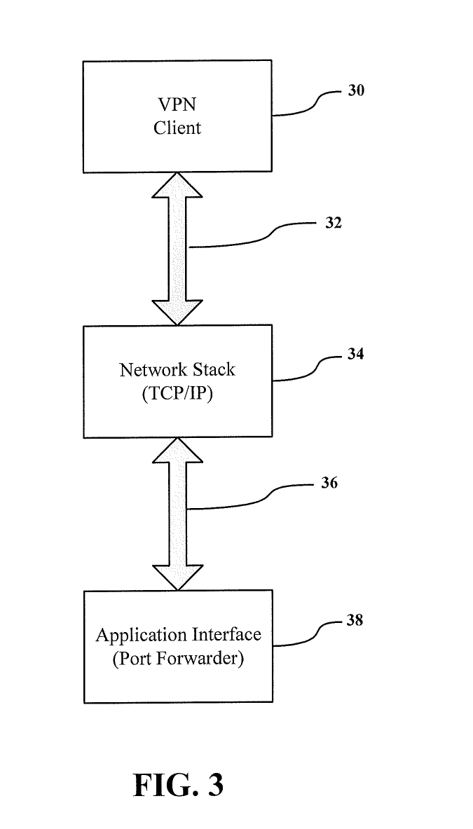

In particular, in one exemplary embodiment of the invention, the VPN library 222 comprises functions and routines for establishing system processes such as depicted in FIG. 3, which operate in non-privileged user space of a computing device for enabling secure VPN communications. As shown in FIG. 3, a user mode VPN client 30 communicates with a user mode network stack (TCP/IP stack) using a communication protocol 32, and the user mode network stack (TCP/IP stack) 34 communicates with the application interface (port forwarder) 38 using communication protocol 36. In one exemplary embodiment of the invention, the user-mode VPN client 30 and user-mode TCP/IP stack 34 are open source applications that are tied together with proprietary code to implement the functions in user space and provide a set of function calls to establish communication with a gateway (e.g. Cisco gateway). The user-mode TCP/IP stack 34 is a lightweight stack that functions like a native stack, but can be controlled in user space.

The communication protocol 32 may be implemented with one of various methods sufficient to establish layer 3 communications between the VPN client 30 and the user mode TCP/IP stack 34. In one exemplary embodiment as discussed in detail below, the communication protocol 32 can be implemented using domain socket file descriptors. Moreover, the communication protocol 36 may be implemented with one of various methods sufficient to handle traffic between the user mode TCP/IP 34 stack and the application interface 38, which ideally do not require special privileged access to the device OS. For instance, in one exemplary embodiment of the invention as discussed in detail below, a loopback method is employed to handle traffic between the user mode TCP/IP 34 stack and the application interface 38. More specifically, in one exemplary embodiment, a loopback method is implemented using a TCP port forwarder process 38, wherein TCP ports are allocated on the OS loopback interface and mapped to internal target host and ports.

In accordance with an exemplary embodiment of the invention, with reference again to FIG. 2, normal internet traffic will flow between the application 220 and the internet 250 using the native network communications stack of the OS 240. However, Intranet traffic or VPN traffic between the application 220 and the private network 260 will be intercepted and forwarded through the Loopback Interface 242 through the VPN library 222 and out as tunneled Intranet traffic 224 to the application 220. In this regard, the application 220 accesses Intranet or VPN traffic on the loopback interface. As noted above, in accordance with aspects of the present invention, a virtual VPN interface is not established in privileged kernel space, but rather, the loop back interface 242 of the native TCP/IP stack of the OS 240 is accessed and certain ports are assigned on the loopback interface 242 to reroute and intercept VPN or Intranet traffic through the VPN library 222.

The VPN network traffic data that is generated by the application 220 and which needs to be secured for VPN communication is passed to the user-mode VPN client 30 where data is encrypted and encapsulated into VPN secured packets and re-addressed to the VPN gateway. Then the encrypted packets are passed to the user-mode TCP/IP stack 34 and re-routed through the loopback interface 242 by the port forwarder 38 to the native communications stack of the OS 240 where the packets are transmitted by the native TCP/IP stack to the private network 260. The user-mode TCP/IP stack 34 is used to communicate between the application layer 220 and the local loop back interface 242. The native TCP/IP stack is used to transmit VPN data traffic from the loopback interface 242 to the private network 260 through the internet 250.

The VPN library 222 monitors the native TCP/IP stack for traffic from a specific intranet IP address that the application 220 wants to communicate with. The application developer specifies a port on the loopback interface for traffic from this IP address to be forwarded to and then monitors it for traffic. Traffic from the target IP address is intercepted from the native TCP/IP stack by the VPN library 222, decrypted, then forwarded to the port on the loopback interface that the application developer has assigned for that traffic and the developer accesses the decrypted VPN traffic there. When the developer transmits traffic to the specified IP address, the developer writes the data to the assigned port on the loopback interface. Traffic flows between the application 220 and the intranet website through this specific port on the loopback interface 242.

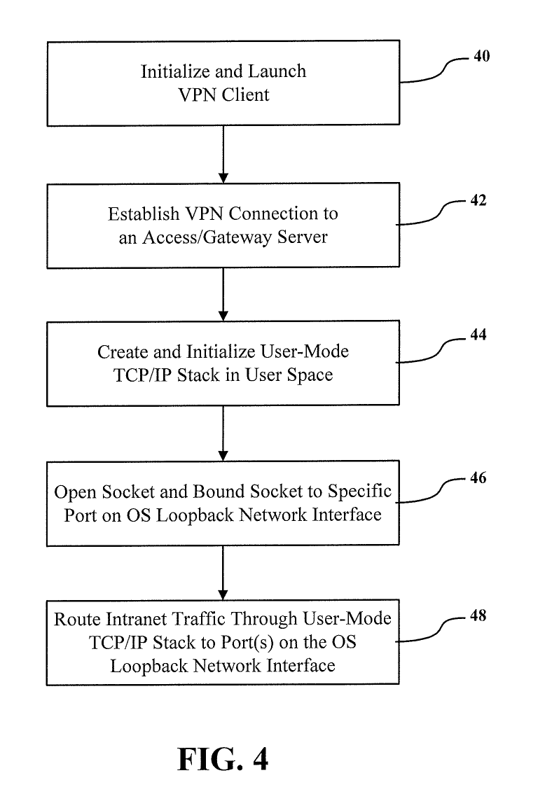

FIG. 4 is a high-level flow diagram of a method for enabling secure VPN communications without privileged root access to a device operating system, according to an exemplary embodiment of the invention. Referring to FIG. 4, initially, a client application with an embedded VPN library is initialized and launched in user space as a non-privileged user (step 40). A VPN connection is then established to an access server (step 42). In this process, the client application calls the VPN library and calls the appropriate functions to establish a VPN connection using the user-mode VPN client. In one exemplary embodiment, a VPN connection is established with the user-mode VPN client using an SSL VPN protocol. A user-mode TCP/IP stack is created and initialized in user space (step 44). A socket is opened and bound to a specific port on the OS loopback network interface (step 46). With this process, the client application listens to a port on the loopback interface for intranet traffic from a given intranet website, wherein the socket is a “tunnel” to the intranet site. Intranet traffic is then routed through the user-mode TCP/IP stack (rather than the OS native TCP/IP stack) to the specified port(s) on the OS loopback network interface (step 48).

With the process of FIG. 4, because both the VPN client and the TCP/IP stack are integrated user-mode process(es), the client software does not require privileged access to the device OS. This scheme provides several benefits. For example, the scheme enables the use of the client software on severely restricted platforms like the iPhone and Android which would otherwise require special privileged access to the OS in order to perform the same functionality. Moreover, this scheme provides a secure, efficient VPN solution for platforms that currently do not have one. Moreover, the scheme provides a highly portable VPN client that can be used on desktops, kiosks, etc., without the installation of any software or device drivers.

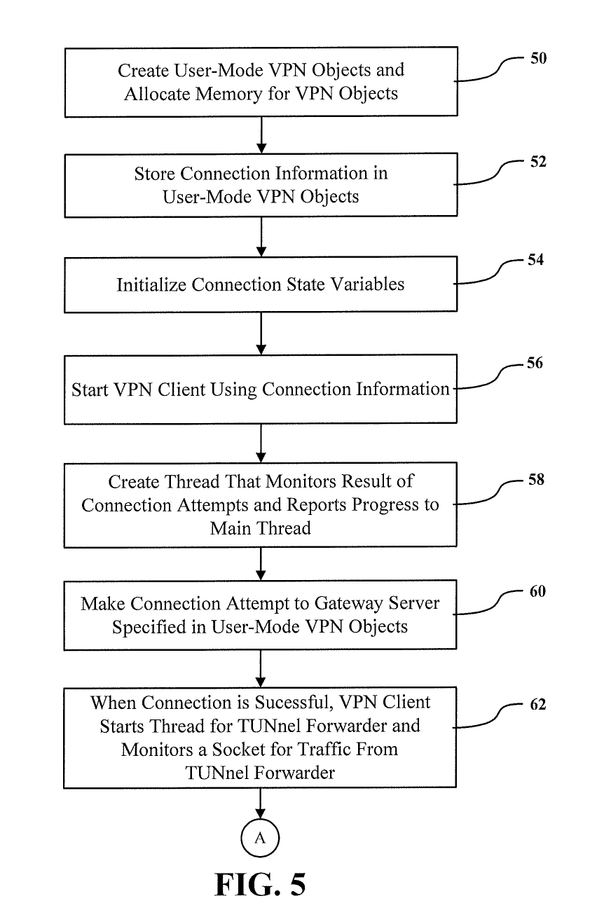

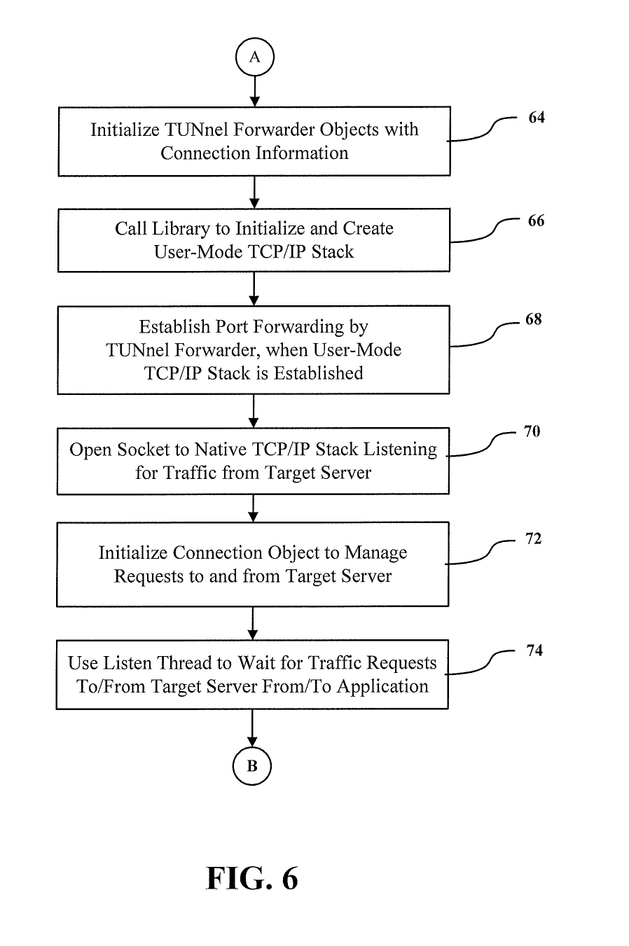

FIGS. 5, 6, and 7 depict a flow diagram of a method for enabling secure VPN communications without privileged root access to a device operating system, according to another exemplary embodiment of the invention. In particular, FIGS. 5, 6 and 7 illustrate a more detailed embodiment of various processing steps discussed above with reference to FIG. 4. For example, steps 50, 52, 54, 56, 58, 60 and 62 of FIG. 5 provide details of steps 40 and 42 of FIG. 4, according to another exemplary embodiment of the invention.

When the client application is launched, an initialization process is performed wherein a plurality of VPN objects are created and memory is allocated for the VPN objects (step 50). More specifically, when the client application is launched, the application will call a “start VPN” function included in the VPN library. This function passes into the library various types of connection information to be stored in the VPN objects. The connection information includes, for example, an IP address of a gateway server, a user name, and password, an address of an intranet server to establish a VPN connection with, and a port number of a port on the local loopback interface to which traffic is forwarded. This connection information is passed into the VPN library and the connection information is stored in the VPN objects (step 52). Thereafter, connection state variables are initialized to commence a VPN connection (step 54).

Next, an attempt is made to create a VPN connection. In one exemplary embodiment, the application calls an “open connection” function in the VPN library which causes a user mode VPN client to be initialized and started using the connection information stored in the VPN objects (step 56). The user-mode VPN client is a fully functional VPN client which is launched by the VPN library to establish a connection to the gateway server that is specified in the connection information stored in the VPN objects. With this connection process, a thread is created to monitor the results of the connection attempt and reports the progress to the main thread (step 58). The user mode VPN client will attempt to connect to a gateway server specified in the connection information (step 60).

When the connection attempt is successful; the user mode VPN client will start a thread for TUNnel Forwarder (a user mode process of the VPN library which handles port forwarding) and monitor a socket for traffic from TUNnel Forwarder (step 62). With this process, a new thread is spawned and detached from the main process, to execute the TUNnel Forwarder library function code.

After the TUNnel Forwarder is commanded to start in its own thread, a port is opened to a target intranet server. In one exemplary embodiment, steps 64, 66 and 68 illustrate an exemplary process flow for opening a port to a target Intranet server. Initially, TUNnel Forwarder objects are initialized with connection information (step 64). The VPN library is then called to initialize and create a user mode TCP/IP stack (step 66). The TUNnel Forwarder thread will then establish port forwarding when the user mode TCP/IP stack is successfully established (step 68).

After port forwarding is established, traffic flow will be established through the port forward process. In one exemplary embodiment, steps 70, 72 and 74 illustrate an exemplary process flow for controlling traffic flow through a user mode port forwarding process. Initially, a socket is opened to the native TCP/IP stack listening for traffic from the target Intranet server (step 70). A connection object is then initialized to manage requests to and from the target Intranet server (step 72). Listen thread then waits for traffic requests to/from the target intranet server from/to the application (step 74). In other words, with the process, a socket is opened to a native TCP/IP stack, and information to a specific address is tunneled from the native TCP/IP stack to the TUNnel Forwarder thread. When traffic goes to or comes from a specific target address through the native TCP/IP stack, the traffic is forwarded to the TUNnel Forwarder process. The TUNnel Forwarder object stores information about the socket, and can subsequently initialize information about the connected port when information is passed to the port from the server.

Next, a new client connection request may be received, wherein a new client (unique IP, application request) requests traffic from target server (step 76). The connection is accepted by the socket to the native TCP/IP stack and a file descriptor is stored in a connection object (step 78). A new user mode socket is created to the local loopback interface at the port specified by the connection information stored in the VPN objects (step 80).

Thereafter, the TUNnel Forwarder process manages traffic between target Intranet server and client application (step 82). In this step, the TUNnel Forwarder process listens to the user mode TCP/IP stack and the native TCP/IP stack and waits for requests from either stack and handles the requests. With application requests, the information will be routed from the user mode TCP/IP stack to the native TCP/IP stack and send the traffic to the Intranet server., and vice versa. The TUNnel Forwarder process monitors sockets and requests until the connection is closed (step 84). Additional socket pairs can be established and closed (native user mode TCP/IP sockets) as separate threads for traffic to/from separate Intranet servers on demand (step 86).

Accordingly, in the exemplary embodiments discussed above, as depicted in FIG. 2, the VPN library code 222 acts as an intermediary between the native TCP/IP stack of the OS 240 and the application 220, which allows the application 220 to access information that would normally require privileged access. For normal Internet traffic flow, the application 220 uses the native network stack and passes traffic to and from the native stack. For special Intranet traffic that requires a VPN connection, the TUNnel Forwarder process of the VPN library 222 forwards traffic through the VPN library 222 through a socket between the native TCP/IP stack and the user mode TCP/IP stack process of the VPN library. The VPN library 222 talks to a server on the Intranet 260 and talks to the application 220. If the application 220 sends traffic to the intranet server, a connection is established between the application and the TUNnel Forwarder process (if a pre-existing connection does not exist). The application writes data to the user mode TCP/IP stack which is handled by the TUNnel Forwarder process. The intranet server TUNnel Forwarder reroutes the network traffic to the local loopback interface. Therefore, the application developer communicates through a user-space artificial TCP/IP stack where the application does not require privilege, wherein the intranet server talks normally to the native TCP/IP stack, except that the traffic goring through the specific server is routed through the code in both directions.

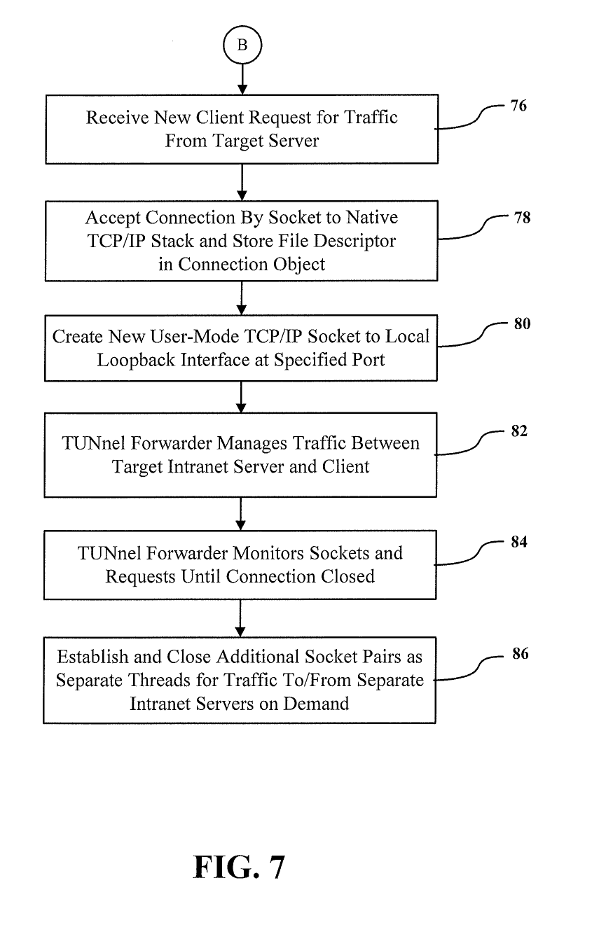

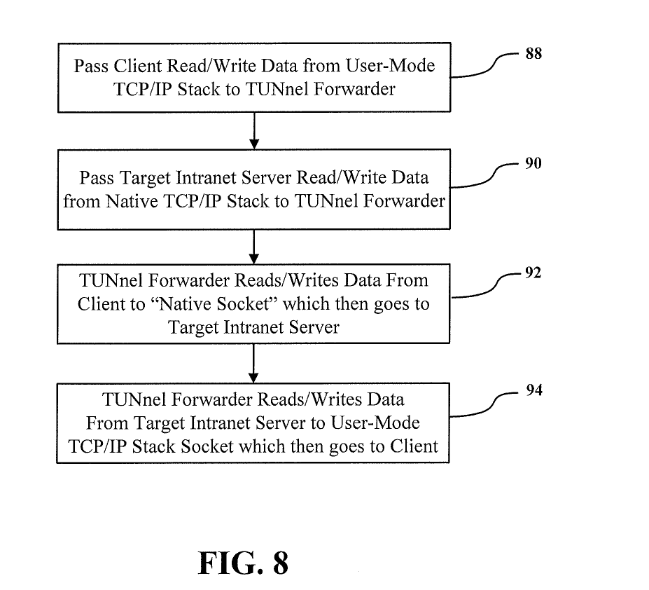

FIG. 8 is a flow diagram illustrating a method for managing traffic between a target intranet server and a client application using a port forwarding user mode process, according to an exemplary embodiment of the invention. More specifically, FIG. 8 illustrates various steps that the TUNnel Forwarder process performs (in step 82 of FIG. 7) for managing traffic between a target Intranet server and the client application. Client read/write data is passed from the user mode TCP/IP stack to the TUNnel Forwarder process (step 88). Target Intranet server read/write data is passed from the native TCP/IP stack to the TUNnel Forwarder process (step 90). The TUNnel Forwarder process reads/writes data from the client application to a “native socket” which then goes to target Intranet server (step 92). The TUNnel Forwarder process reads/writes data from the target Intranet server to a “user mode socket” which then goes to the client application (step 94).

As discussed above with reference to FIG. 3, the user mode VPN client 30 communicates with the user mode network stack (TCP/IP stack) using a communication protocol 32, and the user mode network stack (TCP/IP stack) 34 communicates with the application interface (port forwarder) 38 using communication protocol 36. The communication protocol 32 may be implemented with one of various methods sufficient to establish layer 3 communications between the VPN client 30 and the user mode TCP/IP stack 34. For instance, in one exemplary embodiment as discussed above, the communication protocol 32 can be implemented using domain socket file descriptors. As is known in the art, a socket is a pipe with a file descriptor assigned to each end of the pipe and each file descriptor is an assigned file number, where data is written to/read from each descriptor at the end of the pipe. This scheme follows the TUN interface model discussed above, so any VPN client that leverages TUN interfaces can be readily adapted in this manner.

In another exemplary embodiment, the communication protocol 32 between the user mode VPN client 30 and the user mode TCP/IP stack 34 can be implemented using pipes. This scheme is similar to a socket scheme, but a pipes communication scheme creates a matching pair of file descriptors. The TCP/IP stack 34 writes to one descriptor and the data comes out the other end to the VPN client 30 at the other file descriptor and vice versa.

In another exemplary embodiment, the communication protocol 32 between the user mode VPN client 30 and the user mode TCP/IP stack 34 can be implemented using transport layer interface communications which makes use of data streams rather than file descriptors (in pipes and socket schemes). With this process, data streams are passed between two processes, rather than writing to memory or using file descriptors to read and write from filed. In another exemplary embodiment, the communication protocol 32 between the user mode VPN client 30 and the user mode TCP/IP stack 34 can be implemented by using UNIX System V interprocess messaging primitives, which makes use of shared memory and a system of semaphores to signal when memory is in use.

Furthermore, as noted above, the communication protocol 36 may be implemented with one of various methods sufficient to handle traffic between the user mode TCP/IP 34 stack and the application interface 38, which ideally do not require special privileged access to the device OS. For instance, various loopback methods may be employed to handle traffic between the user mode TCP/IP 34 stack and the application interface 38. More specifically, in one exemplary embodiment, as discussed above, a loopback method is implemented using a TCP port forwarder process, wherein TCP ports are allocated on the OS loopback interface and mapped to internal target host and ports. Traffic is passed through (unmodified). This method is most useful for adapting to existing applications because it simply requires assigning a new URL and requires either little or no code changes. In another exemplary embodiment, a loopback method may be implemented using a UDP port forwarder process. This process is similar to the port forwarding process via the loopback interface, but is a different communication protocol (UDP instead of TCP/IP).

In another exemplary embodiment, a loopback process may be implemented using a DNS interception process. This process requires privileged access (to listen on port 53 and creates 127.0.0.0/8 aliases, and forwards on ports <1024). This scheme implements a DNS server, wherein requests are read, requested host are resolved internally, and then port forwards are automatically set up for the most common services on new 127.0.0.0/8 addresses. For example, assume a user requests access to w3.ibm.com, internal resolution shows that the real host is 10.0.0.1, so the following port forwards are setup:

127.0.0.2:22->XXX.XXX.XXX.XXX:22

127.0.0.2:80->XXX.XXX.XXX.XXX:80

Then the resolver returns 127.0.0.2 as the host. In addition, DNS TTL is used to tear down connections after a certain timeout period.

In another exemplary embodiment, the communication protocol 36 to handle traffic between the user mode TCP/IP 34 stack and the application interface 38 may be implemented using a file accessor scheme. In particular, rather than use the loopback interface method as a connection mechanism, filed can be used wherein a FIFO protocol allows data to be read from and written to a file, and then pass it through the user mode TCP/IP stack to the VPN client. By way of example, the application interface API is used to setup a domain socket (accessed as a file), for example:

$f->createDomainSocket(“/tmp/myforward”, 0600, IP_TCP, “XXX.XXX.XXX.XXX”, 80);

Then, normal file operations can be used to read/write traffic with the remote host, for example:
$fd=fopen(“/tmp/myforward”, “r”);
fwrite($fd, “hello world”);
print stream_get_contents($fd);
fclose($fd);

In another exemplary embodiment, the communication protocol 36 to handle traffic between the user mode TCP/IP 34 stack and the application interface 38 may be implemented using proxy servers (SOCKS, web, FTP, RTSP, gopher, etc.). In addition, the communication protocol 36 can be implemented by direct access to the user mode TCP/IP stack. This is primarily for applications that are written directly for the user mode uVPN communication scheme.

As will be appreciated by one skilled in the art, aspects of the present invention may be embodied as a system, apparatus, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Referring again to FIGS. 1-8, the diagrams in the figures illustrate the architecture, functionality, and operation of possible implementations of systems, methods, and computer program products according to various embodiments of the present invention. In this regard, each block in a flowchart or a block diagram may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagram and/or flowchart illustration, and combinations of blocks in the block diagram and/or flowchart illustration, can be implemented by special purpose hardware-based systems that perform the specified functions or acts, or combinations of special purpose hardware and computer instructions.

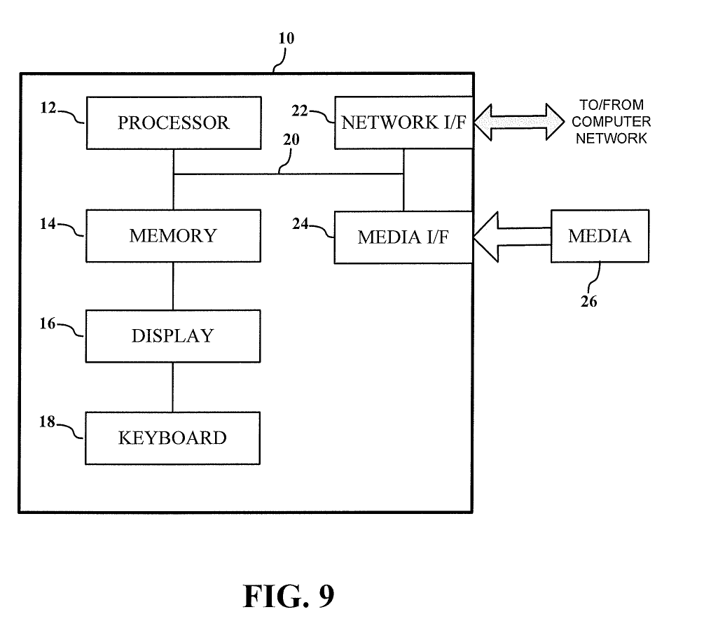

One or more embodiments can make use of software running on a general-purpose computer or workstation. With reference to FIG. 9, such an implementation 10 employs, for example, a processor 12, a memory 14, and an input/output interface formed, for example, by a display 16 and a keyboard 18. The term “processor” as used herein is intended to include any processing device, such as, for example, one that includes a CPU (central processing unit) and/or other forms of processing circuitry. The processing device is preferably capable of processing video files. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, keyboard or mouse), and one or more mechanisms for providing results associated with the processing unit (for example, display or printer).

The processor 12, memory 14, and input/output interface such as display 16 and keyboard 18 can be interconnected, for example, via bus 20 as part of a data processing unit 10. Suitable interconnections, for example, via bus 20, can also be provided to a network interface 22, such as a network card, which can be provided to interface with a computer network, and to a media interface 24, such as a diskette or CD-ROM drive, which can be provided to interface with media 26.

As used herein, a “server” includes a physical data processing system (for example, system 10 as shown in FIG. 9) running a server program. It will be understood that such a physical server may or may not include a display and keyboard.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method for establishing a secure VPN (virtual private network) connection, comprising:
launching a VPN client running in non-privileged user space of a computing device;
launching a network protocol stack running in non-privileged user space of the computing device; and
establishing a secure VPN communication between an application running in non-privileged user space of the computing device and a remote server using the VPN client and network protocol stack running in non-privileged user space.

2. The method of claim 1, wherein launching a VPN client and network protocol stack comprises making functions calls to a VPN library accessible in non-privileged user space of the computing device.

3. The method of claim 2, wherein the VPN library comprises embedded code of the application.

4. The method of claim 1, wherein launching a network protocol stack comprises initializing a user mode TCP/IP protocol stack in non-privileged user space.

5. The method of claim 1, wherein establishing a secure VPN communication comprises forwarding traffic associated with the secure VPN communication through ports on a local loopback interface of an operating system of the computing device to VPN library functions.

6. The method of claim 1, further comprising implementing a communication protocol for communication between the VPN client and the network protocol stack in non-privileged user space.

7. The method of claim 7, wherein the communication protocol is implemented using sockets.

8. The method of claim 7, wherein the communication protocol is implemented using pipes.

9. The method of claim 7, wherein the communication protocol is implemented using transport layer interface communications using data streams.

10. The method of claim 7, wherein the communication protocol is implemented using interprocess messaging primitives.

11. The method of claim 1, further comprising launching a port forwarder process running in non-privileged user space of the computing device, which controls forwarding and rerouting of secure VPN traffic through a loopback process.

12. The method of claim 11, wherein the loopback process comprises TCP port forwarding secure VPN traffic through a loopback interface of a native TCP/IP stack.

13. The method of claim 11, wherein the loopback process comprises a DNS (domain name server) interception process.

14. An article of manufacture comprising a computer readable storage medium comprising program code embodied thereon, which when executed by a computer, performs a method for establishing a secure VPN (virtual private network) connection, the method comprising:
launching a VPN client running in non-privileged user space of a computing device;
launching a network protocol stack running in non-privileged user space of the computing device; and
establishing a secure VPN communication between an application running in non-privileged user space of the computing device and a remote server using the VPN client and network protocol stack running in non-privileged user space.

15. The article of manufacture of claim 14, wherein launching a VPN client and network protocol stack comprises making functions calls to a VPN library accessible in non-privileged user space of the computing device.

16. The article of manufacture of claim 15, wherein the VPN library comprises embedded code of the application.

17. The article of manufacture of claim 14, wherein launching a network protocol stack comprises initializing a user mode TCP/IP protocol stack in non-privileged user space.

18. The article of manufacture of claim 14, wherein establishing a secure VPN communication comprises forwarding traffic associated with the secure VPN communication through ports on a local loopback interface of an operating system of the computing device to VPN library functions.

19. The article of manufacture of claim 14, further comprising program code which is executable for implementing a communication protocol for communication between the VPN client and the network protocol stack in non-privileged user space.

20. The article of manufacture of claim 14, further comprising program code which is executable for launching a port forwarder process running in non-privileged user space of the computing device, which controls forwarding and rerouting of secure VPN traffic through a loopback process.

21. The article of manufacture of claim 14, wherein the loopback process comprises TCP port forwarding secure VPN traffic through a loopback interface of a native TCP/IP stack.

22. A system for establishing a secure VPN (virtual private network) connection, comprising:
a memory; and
a processor coupled to the memory and configured to execute code stored in the memory for:
launching a VPN client running in non-privileged user space of a computing device;
launching a network protocol stack running in non-privileged user space of the computing device; and
establishing a secure VPN communication between an application running in non-privileged user space of the computing device and a remote server using the VPN client and network protocol stack running in non-privileged user space.

23. The system of claim 22, wherein launching a user mode VPN client and user mode network protocol stack comprises making functions calls to a VPN library accessible in non-privileged user space of the computing device.

24. The system of claim 22, wherein the VPN library comprises embedded code of the application.

25. The system of claim 22, wherein establishing a secure VPN communication comprises forwarding traffic associated with the secure VPN communication through ports on a local loopback interface of an operating system of the computing device to VPN library functions.
